(19) United States
(12) Patent Application Publication
(10) Pub. No.: US 2010/0024920 A1
(43) Pub. Date: Feb. 4, 2010

(54) FINGER JOINT CUTTING TOOL AND ASSEMBLY HAVING STACKED BLADE ASSEMBLIES

(76) Inventor: Raliegh J. Jensen, Boise, ID (US)

Correspondence Address: HOLLAND LAW OFFICE P.L.L.C., P.O. BOX 1840, BOISE, ID, 83701-1840, US

(21) Appl. No.: 12/182,712

(22) Filed: Jul. 30, 2008

(51) Int. Cl. B27C 5/00

(52) U.S. Cl. 144/230

(57) ABSTRACT

A finger joint cutting tool and tool assembly having stacked blade assemblies. The finger joint cutting tool includes a tool body with a plurality of cutter blade assemblies positioned and fixed at substantially equal intervals about the periphery of the tool body each including a plurality of blades stacked in a side-by-side arrangement. The blades are oriented and fixed to extend beyond the periphery of the tool body in a cutting position. Preferably, each of the blades includes a first cutting edge and a second cutting edge wherein either the first cutting edge or the second cutting edge may be oriented for cutting and each of the cutting edges of the blades are capable of being re-sharpened. A tool assembly includes multiple finger joint cutting tools mounted side by side on a shaft or spindle for rotation about an axis.

### BACKGROUND OF THE INVENTION

1. Technical Field

This invention relates generally to cutting tools mountable and more particularly to a finger joint cutting tool and assembly mountable on a rotatable spindle, for cutting tool cuts finger joints along the edge of a work piece for joining two such work pieces. More particularly, this invention relates to a finger joint cutting tool having a stacked blade assembly.

2. Background

Cooperating finger joint cuts are used to join two work pieces together, generally but not exclusively formed of wood, to form one continuous larger piece. Finger joint cutting is an economical process to produce a length of material from a number of shorter pieces by providing matching or cooperating surfaces at the ends of the pieces which can be fitted together and glued.

U.S. Pat. No. 3,951,189 to Cromeens discloses an apparatus for carrying out the finger joint cutting process. Generally, a finger joint cutter head is mounted on the spindle of a shaper apparatus through which the shorter pieces of material are fed.

U.S. Pat. No. 3,951,189 to Benson discloses a stacked disc cutter assembly for producing finger joints including a plurality of discs, each disc having a plurality of cutter teeth secured to and projecting radially from a periphery of the disc. The discs are of substantially similar outer diameter and when assembled and secured together in side-by-side, contiguous, concentric relationship they form a solid cylindrical core for the assembly. The cutter teeth project radially outwardly from the discs and so arranged on the discs that they are spaced apart both axially and circumferentially of the cutter assembly.

U.S. Pat. No. 5,005,619 to Jensen discloses a finger joint cutter head having a plurality of individual claw-shaped cutter blades that are stacked one on top of another to form cutter blade assemblies which in turn are annularly secured via bolts between the top and bottom plate of the cutter head. The top and bottom plates are attached in parallel spaced relation to an arbor collar. The top and bottom plates extend radially outward from the arbor collar.

U.S. Pat. No. 5,368,078 to Rupe discloses a composite cutter blade for a finger joint cutter head that includes a cantilevered cutting tip that is brazed to a backing member. Multiple sets of these composite cutter blades are held in stacked arrangements about a periphery of a cutter head.

U.S. Pat. No. 6,161,602 to Erbs discloses a finger joint cutting tool that includes a plurality of unitary finger joint cutter bits each having a unitary body from which a plurality of integrally formed finger cutting teeth extend for finger jointing wood materials.

U.S. Pat. No. 6,644,896 to Tinuma discloses a milling cutter for slotting having a plurality of adjacent projecting cutting blades integrally formed in a comb shape in a replaceable blade bodies.

What is needed is a finger joint cutting tool having a cutter blade assembly which allows for a wide variety of blade spacing while employing a single cutter body. Additionally, it would be advantageous to provide a finger joint cutting tool that includes individual blades that are removable and reversible allowing the blade to be positioned and fixed with respect to the cutter body so that either end of the blade may project from the cutter body for cutting.

It is, therefore, an object of the present invention to provide a cutter blade assembly for a finger joint cutting tool which allows for a wide variety of blade spacings while employing a single cutter body. Yet another object of the present invention to provide a cutter blade assembly for a finger joint cutting tool that includes individual blades that are removable and reversible allowing the blades to be arranged in the cutter blade assembly and positioned and fixed with respect to the cutter body so that either a first of second end of the blade is selected to project from the cutter body for cutting thereby effectively doubling blade life.

### SUMMARY OF THE INVENTION

The present invention is directed to a finger joint cutting tool that includes a tool body having a spindle aperture adapted to permit mounting of the tool on a shaft or spindle. The finger joint cutting tool of the present invention also includes a cutter blade assembly having at least two blades arranged in a stacked side-by-side arrangement, the cutter blade assembly positioned and fixed along a periphery of the tool body receiver the at least two blades oriented to extend beyond the periphery of the tool body. A finger joint cutting tool assembly according to the present invention includes at least two finger joint cutting tools positioned side-by-side in such a manner that a constant blade interval is maintained between the blades of the joint cutting tools.

In a preferred embodiment of the invention, a finger joint cutting tool includes a tool body having a plurality of blade assembly receivers formed at substantially equal intervals about the periphery of a tool body. A plurality of cutter blade assemblies each including a plurality of blades stacked in a side-by-side arrangement are positioned and fixed, one cutter blade assembly in each of the blade assembly receivers. Again, the blades are oriented and fixed to extend beyond the periphery of a tool body in a cutting position. In the preferred embodiment of the invention, each of the plurality of blades includes a first cutting edge and a second cutting edge wherein either the first cutting edge or the second cutting edge of each of the plurality of blades may be oriented for cutting each of the plurality of blades oriented to extend beyond the periphery of a tool body.

In a preferred embodiment the finger joint cutting tool includes a plurality of cutter blade assemblies each cutter blade assembly including a plurality of root blades stacked in an alternating side-by-side arrangement with a plurality of trim blades. The root blades are configured to cut the root or valley of a finger joint while the trim blades are configured to trim the root to a selected depth. Alternately each blade may be configured so that both a root blade and a trim blade are incorporated in a singe blade and a plurality of blades that are so configured may be stacked in a side-by-side arrangement to form a cutter assembly.

In the preferred embodiment of the invention, each finger joint cutting tool is configured such that multiple finger joint cutting tools may be mounted on a spindle or shaft in a side by side configuration such that the interval between the blades of consecutive or adjacent tools are equal to the interval between the blades of either tool.

The foregoing has outlined rather broadly the features and technical advantages of the present invention so that the detailed description of the invention that follows may be better understood. Additional features and advantages of the invention will be described hereinafter, which form the subject of the invention. It should be appreciated by those skilled in the art that the conception and the specific embodiments disclosed might be readily used as a basis for modification or design of devices for carrying out the same purposes of the present invention. It should also be realized by those skilled in the art that such equivalent constructions do not depart from the spirit and scope of the invention as set forth herein.

### BRIEF DESCRIPTION OF THE DRAWINGS

FIG. 1 is a representative isometric view of a finger joint cutting tool assembly according to the present invention;

FIG. 2 is a representative side view of a finger joint cutting tool according to the present invention;

FIG. 3 is a representative top view of the finger joint cutting tool according to the present invention;

FIG. 4 is a representative rear view of the finger joint cutting tool according to the present invention;

FIG. 5 is a representative partial top view detail of the finger joint cutting tool according to the present invention;

FIG. 6 is a representative partial rear view detail of the finger joint cutting tool according to the present invention;

FIG. 7 is a representative partially exploded isometric view of a finger joint cutting tool according to the present invention;

FIG. 8 is a representative exploded isometric view of a blade assembly for a finger joint cutting tool according to the present invention;

FIG. 9 is a representative exploded isometric view of a blade assembly for a finger joint cutting tool according to the present invention;

FIG. 10 is a representative side view of a finger joint cutting tool assembly according to the present invention; and

FIG. 11 is a representative front view of a finger joint cutting tool assembly according to the present invention.

### BEST MODE FOR CARRYING OUT INVENTION

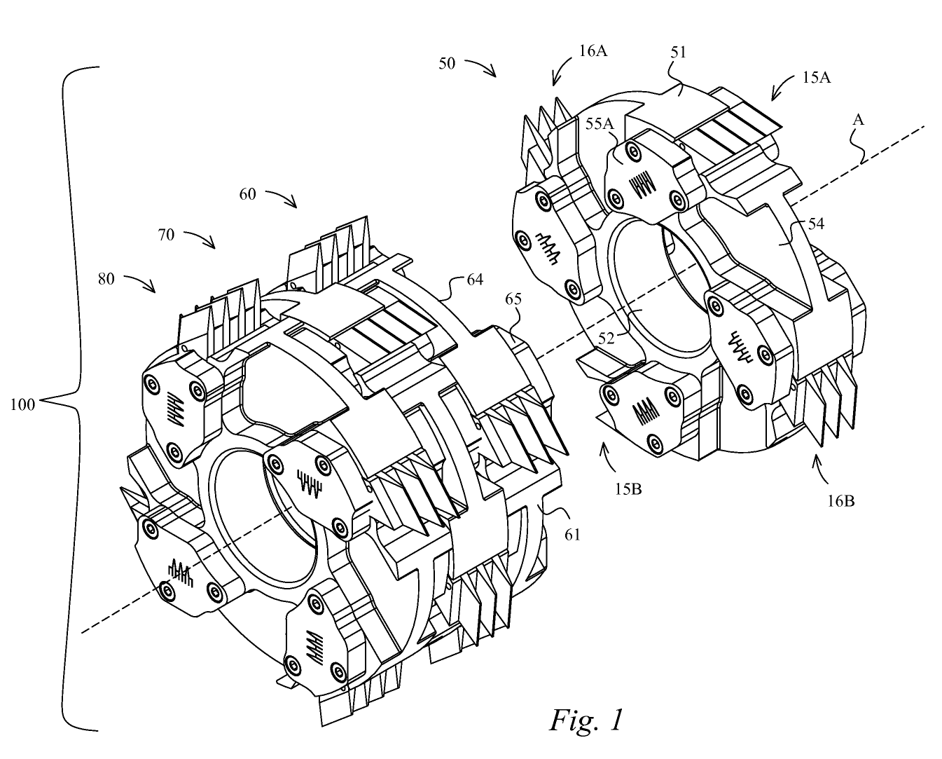

Referring to FIG. 1, finger joint cutting tool assembly 100 is shown including a plurality of finger joint cutting tools 50, 60, 70 and 80 that may be mounted axially along axis A in a side by side assembly on a shaft or spindle, (not shown), as is well known in the art. Finger joint cutting tool 50, which is typical of finger joint cutting tools 60, 70 and 80 is shown including tool body 51 having spindle aperture 52 configured for attaching finger joint cutting tool 50 to a spindle of a drive motor, (not shown), as is well known in the art. As shown, finger joint cutting tool 50 includes a plurality of cutter blade assemblies 15A, 15B, 16A and 16B each located about a periphery of tool body 51. Tool body 51 also includes a plurality of end cap recesses, typified by end cap recess 54, four on each side of tool body 51. As seen in FIG. 1, end cap 65, aligns with end cap recess 54. Similarly, end cap 55A of cutter blade assembly 15A aligns with end cap recess 64 of tool body 61. In a similar manner each of the plurality of aligning end cap recesses and end caps typified by end cap 65 and end cap recess 54 and end cap 55A and end cap recess 64 are configured to permit an associated end cap to nest in the corresponding end cap recess in such a manner that allows a close side by side assembly of finger joint cutting tools 50, 60, 70 and 80 to form finger joint cutting tool assembly 100.

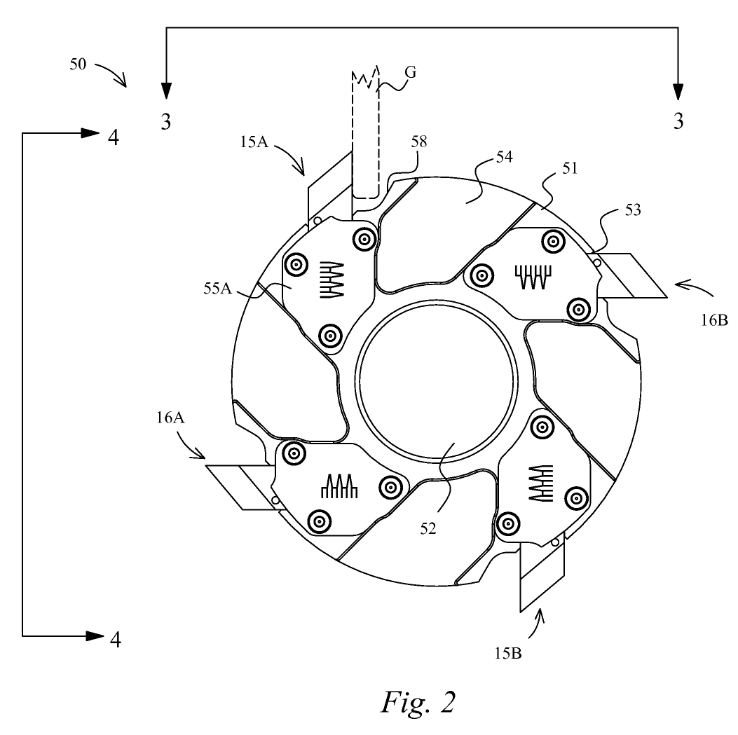

Referring to FIG. 2, finger joint cutting tool 50 is shown including tool body 51 having spindle aperture 52 and a plurality of cutter blade assemblies 15A, 15B, 16A and 16B each located about a periphery of tool body 51, positioned and fixed in one of the plurality of cutter assembly receivers, typified by cutter assembly receiver 53. End cap 55A is shown attached to tool body 51 and assists in retaining cutter blade assembly 15A in cutter assembly receiver 53. Tool body 51 also includes a plurality of end cap recesses, typified by end cap recess 54, four on each side of tool body 51. In the preferred embodiment tool body 51 is formed having grinding wheel cope 58 which allows access of grinding wheel G to face the cutting edges of cutter blade assemblies 15A.

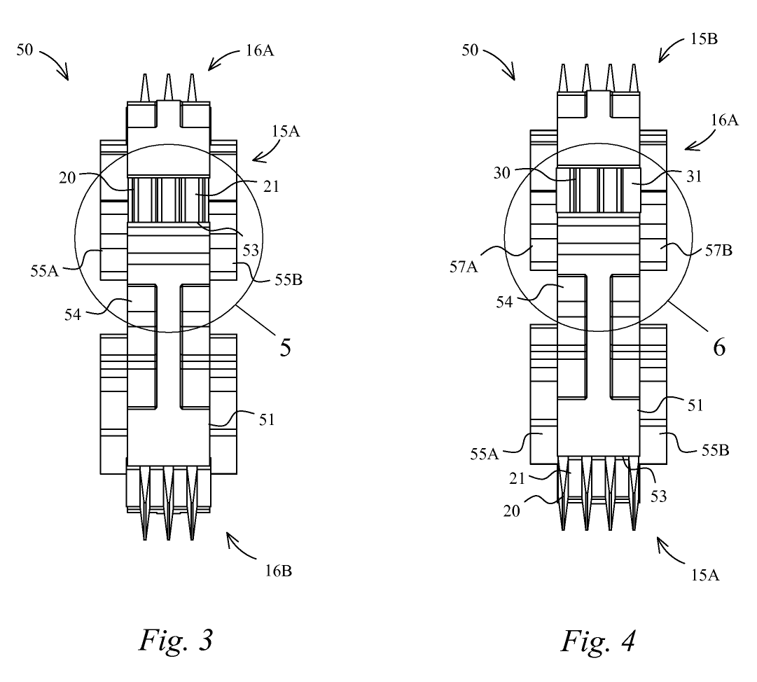

FIG. 3 shows a top view of finger joint cutting tool 50 including tool body 51 having a plurality of cutter assembly receivers, typified by cutter assembly receiver 53 as well as a plurality of end cap recesses, typified by end cap recess 54. Also shown in FIG. 3 are cutter blade assemblies 15A, 16A and 16B each positioned and fixed in one of the plurality of cutter assembly receivers, typified by cutter assembly receiver 53. FIG. 3 shows cutter blade assembly 15A including a plurality of root blades 20 and trim blades 21 positioned in cutter assembly receiver 53 in an alternating stacked side-by-side arrangement. End caps 55A and 55B are shown attached to tool body 51 and retain cutter blade assembly 15A in cutter assembly receiver 53. In the embodiment shown in FIGS. 3 and 4, cutter blade assembly 15A includes four root blades indicated generally by the reference to root blade 20 and three trim blades indicated generally by the reference to trim blade 21.

FIG. 4 shows a rear view of finger joint cutting tool 50 including tool body 51 having a plurality of cutter assembly receivers, typified by cutter assembly receiver 53 as well as a plurality of end cap recesses, typified by end cap recess 54. Also shown in FIG. 4 are cutter blade assemblies 15A, 15B and 16A each positioned and fixed in one of the plurality of cutter assembly receivers, typified by cutter assembly receiver 53. End caps 57A and 57B are shown attached to tool body 51 and retain cutter blade assembly 16A. Similarly, end caps 55A and 55B are shown attached to tool body 51 and retain cutter blade assembly 15A. FIG. 4 shows cutter blade assembly 16A including a plurality of root blades 30 and trim blades 31 positioned in alternating stacked side-by-side arrangement. Cutter blade assembly 16A includes three root blades indicated generally by the reference to root blade 30 and four trim blades indicated generally by the reference to trim blade 31.

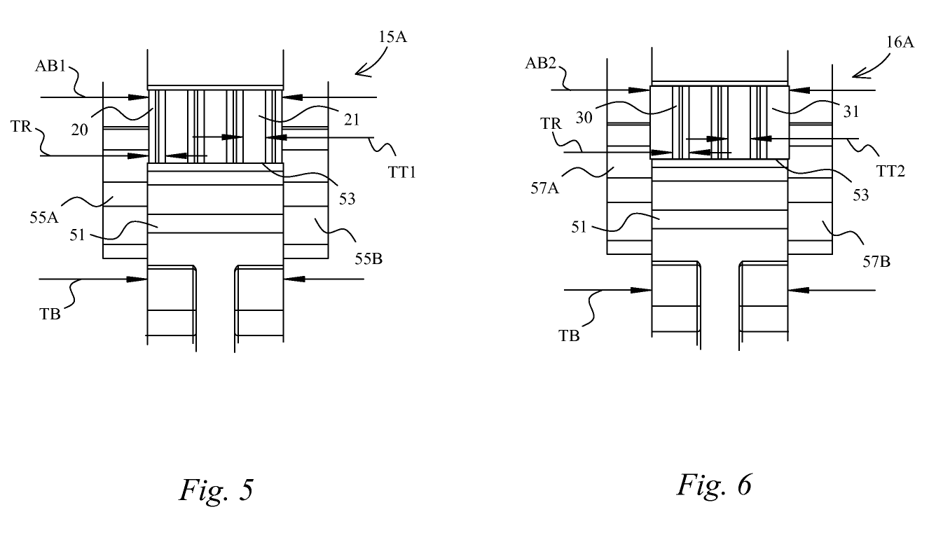

FIG. 5 is a partial top view detail showing cutter blade assembly 15A located in cutter assembly receiver 53 and retained by end caps 55A and 55B. As shown cutter blade assembly 15A includes a plurality of root blades typified by root blade 20 positioned in an alternating stacked side by side arrangement with a plurality of trim blades typified by trim blade 21. Each of the root blades 20 includes a specified thickness as indicated by the reference TR. Similarly, each of the trim blades 21 includes a specified thickness as indicated by the reference TT1. The aggregate thickness of the root blades 20 and trim blades 21 equal the blade assembly thickness AB1, which in the embodiment shown is slightly less than body thickness TB of tool body 51.

FIG. 6 is a partial side view detail showing cutter blade assembly 16A retained by end caps 57A and 57B. As shown cutter blade assembly 16A includes a plurality of root blades typified by root blade 30 positioned in a stacked side by side arrangement with a plurality of trim blades typified by trim blade 31. Again, each of the root blades 30 includes a specified thickness as indicated by the reference TR. Each of the trim blades 31 includes a specified thickness as indicated by the reference TT2. The aggregate thickness of the root blades 30 and trim blades 31 equal the blade assembly thickness AB2, which in the embodiment shown is slightly greater than body thickness TB of tool body 51.

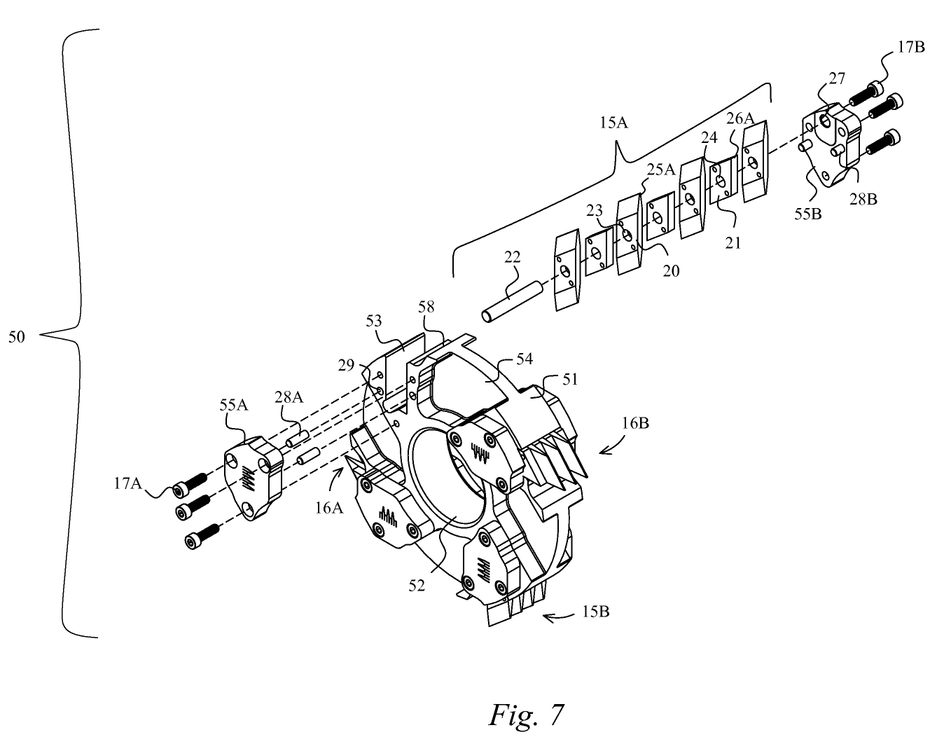

Referring to FIG. 7, finger joint cutting tool 50 is shown once again including tool body 51 having spindle aperture 52 configured for attaching finger joint cutting tool 50 to a shaft or spindle, (not shown). Finger joint cutting tool 50 includes a plurality of cutter blade assemblies 15A, 15B, 16A and 16B each located about a periphery of tool body 51, positioned and fixed in one of the plurality of cutter assembly receivers, typified by cutter assembly receiver 53. Tool body 51 also includes a plurality of end cap recesses, typified by end cap recess 54, four on each side of tool body 51.

Cutter blade assembly 15A is shown in an exploded arrangement in FIG. 7. Cutter blade assembly 15A includes four root blades indicated generally by the reference to root blade 20 positioned in an alternating stacked side-by-side arrangement with three trim blades indicated generally by the reference to trim blade 21. The alternating root blades 20 and trim blades 21 are positioned and fixed in cutter assembly receiver 53 and alignment dowel 22 is inserted through root blade alignment aperture 23 of each root blade 20 and the trim blade alignment aperture 24 of each trim blade 21. End caps 55A and 55B each include an alignment aperture 27 into which the ends of alignment dowel 22 extend. End cap 55A includes a pair of locator pins 28A while end cap 25B includes locator pins 28B. Locator pins 28B insert into locator apertures 29 formed in tool body 51. Screws 17A secure end cap 55A to tool body 51 while screws 17B secure end cap 55B to tool body 51. Grinding wheel cope 58 is configured to permit grinding wheel G to face the cutting edge 25A of the root blades 20 and cutting edge 26A of the trim blades 21 of cutter blade assembly 15A when cutter blade assembly 15A is positioned and fixed in cutter assembly receiver 53.

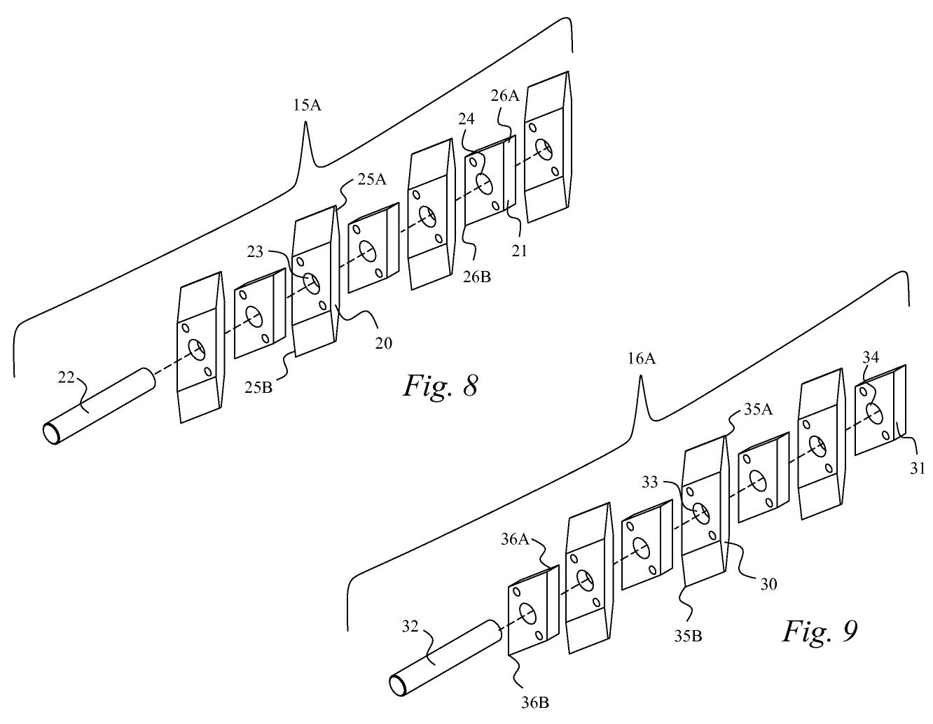

Referring to FIG. 8, details of cutter assembly 15A are shown to advantage. Cutter blade assembly 15A includes four root blades indicated generally by the reference to root blade 20 positioned in alternating stacked side-by-side arrangement with three trim blades indicated generally by the reference to trim blade 21. The alternating root blades 20 and trim blades 21 are positioned in an alternating stacked side-by-side arrangement and alignment dowel 22 is inserted through root blade alignment aperture 23 of each root blade 20 and the trim blade alignment aperture 24 of each trim blade 21.

Each root blade 20 includes a first cutting edge 25A and a second cutting edge 25B. Both the first cutting edge 25A and the second cutting edge 25B may be re-sharpened to further extend the service life of the root blade 20. When cutter assembly 15A has been in operation until such time that first cutting edge 25A is dulled, each root blade 20 may be reversed end for end so that the second cutting edge 25B is exposed for cutting. Similarly, each trim blade 21 includes a first cutting edge 26A and a second cutting edge 26B. Again when the first cutting edge 26A is dulled it may be re-sharpened or in the alternative, each trim blade 21 may be reversed end for end so that the second cutting edge 26B is exposed for cutting.

Referring to FIG. 9, cutter assembly 16A includes three root blades indicated generally by the reference to root blade 30 positioned in an alternating stacked side-by-side arrangement with four trim blades indicated generally by the reference to trim blade 31. The alternating root blades 30 and trim blades 31 are positioned in an alternating stacked side-by-side arrangement and alignment dowel 32 is inserted through each root blade alignment aperture 33 of each root blade 30 and the trim blade alignment aperture 34 of each trim blade 31. As seen in FIG. 9, each root blade 30 includes a first cutting edge 35A and a second cutting edge 35B. Similarly, each trim blade 31 includes a first cutting edge 36A and a second cutting edge 36B.

In a preferred embodiment of the invention, root blades 20 and trim blades 21, (FIG. 8), and root blades 30 and trim blades 31, (FIG. 9), are formed of a hardened steel, a carbide steel or by any of a variety of materials commonly employed in forming blades or knives for joint cutting. Additionally, the root blades 20 and trim blades 21, (FIG. 8), and root blades 30 and trim blades 31, (FIG. 9), are formed so that a slip fit between the blade assembly and the associated cutter assembly receiver 53 results. This close tolerance fit together with the use of an alignment dowel 22 or 32 that is also formed having a slip fit with respect to root blade alignment apertures 23 and 33 of each root blades 20 and 30 respectively, the trim blade alignment apertures 24 and 34 of each trim blade 21 and 31 respectively and the alignment apertures 27 formed in end caps 55A and 55B results in a substantially rigid configuration when end caps 55A and 55B are secured to tool body 51 by screws 17A and 17B.

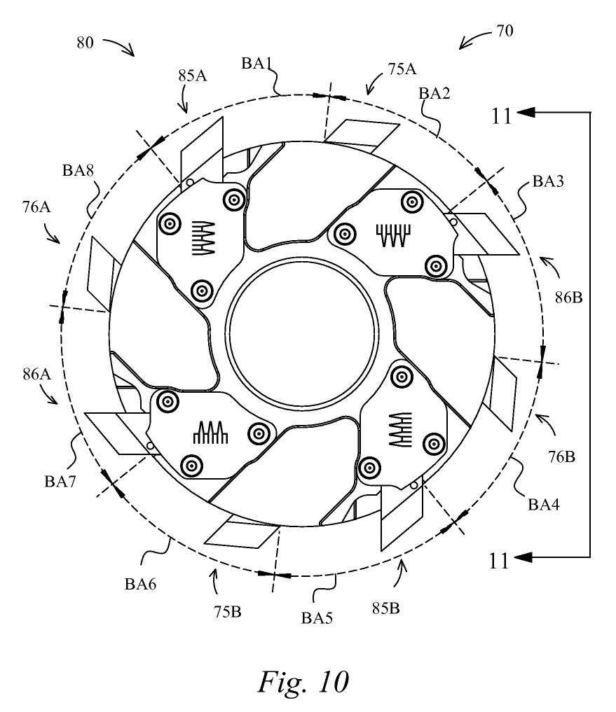

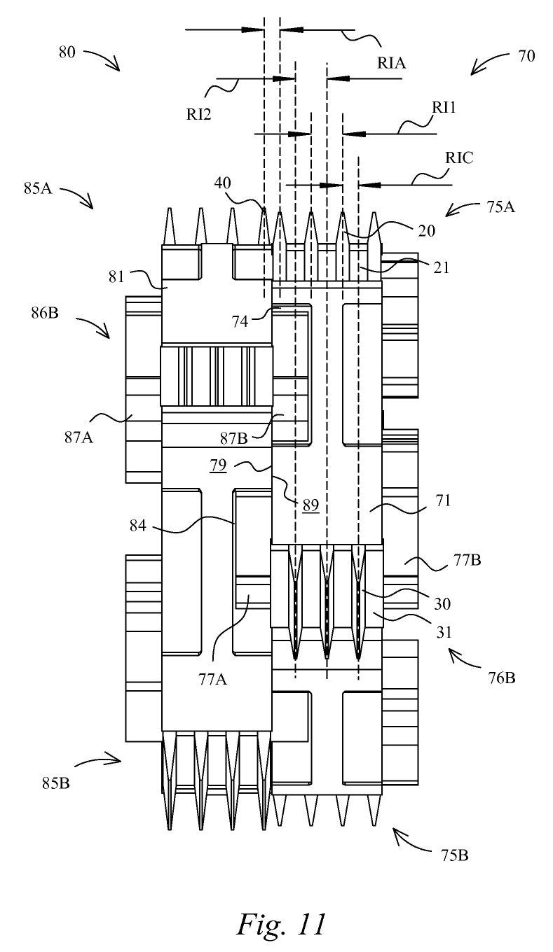

FIGS. 10 and 11 show cutting tools 70 and 80 positioned in side by side relationship to one another typical of a multi-tool application as shown in FIG. 1. Cutting tool 70 includes cutter assemblies 75A, 76A, (FIG. 10), 75B and 76B. Cutting tool 80 includes cutter assemblies 85A, 86A, (FIG. 10), 85B and 86B. Referring to FIG. 10, when mounted side by side as shown, an interval of forty-five degrees is observed between successive blade assemblies 75A, 85A, 76A, 86A, 75B, 85B, 76B and 86B of cutting tools 70 and 80 as they are presented in rotation. The substantially equal blade assembly intervals are identified by the references BA1, BA2, BA3 . . . through BA8.

Referring to FIG. 11, cutting tool 70 is shown including tool body 71 having a plurality of end cap recesses typified by end cap recess 74. Similarly, cutting tool 80 is shown including tool body 81 having a plurality of end cap recesses typified by end cap recess 84. FIG. 11 also shows end caps 87A and 87B associated with cutter assembly 86B and end caps 77A and 77B associated with cutter assembly 76B. When positioned side by side as shown in FIG. 11 face 79 of cutting tool 70 lies flush against face 89 of cutting tool 80. As previously described, the plurality of aligning end cap recesses, typified by end cap recess 74 of cutting tool 70 and end cap recess 84 of cutting tool 80 and end caps typified by end cap 77A of cutting tool 70 and end cap 87B of cutting tool 80 are configured to permit an associated end cap to nest in the corresponding end cap recess in such a manner that allows a close side by side assembly of finger joint cutting tools 70 and 80. FIG. 11 shows end cap 77A of cutting tool 70 nested in end cap recess 84 of cutting tool 80 and end cap 87B of cutting tool 80 nested in end cap recess 74 of cutting tool 70.

FIG. 11 also shows the alternating stacked side-by-side arrangement of the plurality of root blades 20 and trim blades 21 of cutter assemblies having four root blades and three trim blades, typified by blade assembly 75A, resulting in a cutter blade assembly having a root blade interval RI1. Similarly, the alternating stacked side-by-side arrangement of the plurality of root blades 30 and trim blades 31 of cutter assemblies having three root blades and four trim blades, typified by blade assembly 76B, results in a cutter blade assembly having a root blade interval RI2. It should be appreciated in reviewing FIG. 11 that root blade interval RI1 is equal to root blade interval RI2. FIG. 11 also illustrates that the offset between the root blades 20 of blade assembly 75A and the offset between the of root blades 30 of blade assembly 76B creates a combined root blade interval RIC that is equal to one-half root blade interval RI1 or root blade interval RI2. Finally, FIG. 11 shows that the offset between the root blades 20 of blade assembly 75A and the root blades 40 of blade assembly 85A creates an assembled root blade interval RIA that is equal to and root blade interval RIC. It should be also appreciated in reviewing FIG. 11 that the fact that assembled root blade interval RIA that is equal to root blade interval RIC allows numerous cutting tools, typified by cutting tool 70 and cutting tool 80 to be assembled on a shaft for rotation while maintaining a desired or specified root blade interval across the full width of a finger joint cutting tool assembly 100, as shown in FIGS. 1 and 11.

While the invention has been described in connection with the preferred embodiment, it is not intended to limit the scope of the invention to the particular form set forth, but, on the contrary, it is intended to cover such alternatives, modifications and equivalents as may be included within the spirit and scope of the invention as defined by the appended claims.

What is claimed is:

1. A finger joint cutting tool comprising:
a tool body including receiver a spindle aperture; and
a cutter blade assembly including at least two blades stacked in a side-by-side arrangement, the cutter blade assembly positioned and fixed along a periphery of the tool body receiver the at least two blades oriented to extend beyond the periphery of the tool body.

2. The finger joint cutting tool of claim 1 wherein at least one blade of the at least two blades further comprises a reversible blade having a first cutting edge and a second cutting edge and wherein either the first cutting edge or the second cutting edge of the at least one blade may be oriented to extend beyond the periphery of the tool body cutting.

3. The finger joint cutting tool of claim 1 further comprising
a plurality of cutter blade assemblies, each of the plurality of cutter blade assemblies including a plurality of blades stacked in a side-by-side arrangement, each of the plurality of cutter blade assemblies positioned and fixed about the periphery of the tool body, each of the plurality of blades oriented to extend beyond the periphery of the tool body.

4. The finger joint cutting tool of claim 1 further comprising
a plurality of cutter blade assemblies, each of the plurality of cutter blade assemblies including a plurality of blades stacked in a side-by-side arrangement, each of the plurality of cutter blade assemblies positioned and fixed at substantially equal intervals about a periphery of the tool body, each of the plurality of blades oriented to extend beyond the periphery of the tool body.

5. The finger joint cutting tool of claim 1 wherein the cutter blade assembly further comprises at least one root blade and one trim blade.

6. The finger joint cutting tool of claim 4 wherein the plurality of cutter blade assemblies further at least one root blade and one trim blade.

7. The finger joint cutting tool of claim 4 wherein each of the plurality of blades further comprise a first cutting edge and a second cutting edge wherein either the first cutting edge or the second cutting edge of each of the plurality of blades may be oriented for cutting.

8. The finger joint cutting tool of claim 5 wherein each of the plurality of blades further comprise a first cutting edge and a second cutting edge wherein either the first cutting edge or the second cutting edge of each of the plurality of blades may be oriented for cutting.

9. A finger joint cutting tool operably couplable to a spindle of a drive motor for rotation about an axis, the finger joint cutting tool comprising:
a tool body including a spindle aperture and a plurality of blade assembly receivers formed about a periphery of the tool body; and
a plurality of cutter blade assemblies, each of the plurality of cutter blade assemblies including a plurality of blades stacked in an alternating side-by-side arrangement, each of the plurality of cutter blade assemblies positioned and fixed in one of the plurality of blade assembly receivers, each of the plurality of blades oriented to extend beyond the periphery of the tool body.

10. The finger joint cutting tool of claim 9 further comprising:
a plurality of end caps, one end cap attached to the tool body at each of the plurality of blade assembly receivers, each of the plurality of end caps adapted to retain one of the plurality of cutter blade assemblies in one of the plurality of blade assembly receivers; and
an alignment dowel that extends through an alignment aperture located in each of the plurality of blades of one of the plurality of cutter blade assemblies for aligning one of the plurality of cutter blade assemblies in one of the plurality of blade assembly receivers.

11. The finger joint cutting tool of claim 9 further comprising:
a plurality of blade assembly receivers formed at equal intervals about the periphery of the tool body.

12. The finger joint cutting tool of claim 9 wherein each of the plurality of blades further comprise at least one root blade and one trim blade stacked in an alternating side-by-side arrangement.

13. The finger joint cutting tool of claim 9 wherein each of the plurality of blades further comprise a first cutting edge and a second cutting edge wherein either the first cutting edge or the second cutting edge of each of the plurality of blades may be oriented for cutting.

14. The finger joint cutting tool of claim 12 wherein each of the plurality of blades further comprise a first cutting edge and a second cutting edge wherein either the first cutting edge or the second cutting edge of each of the plurality of blades may be oriented for cutting.

15. A finger joint cutting tool assembly operably couplable to a spindle of a drive motor for rotation about an axis, the finger joint cutting tool assembly comprising:
at least two tool bodies, each tool body including a spindle aperture adapted for placement about the spindle of the drive motor, each tool body including a plurality of blade assembly receivers formed about a periphery of the tool body, each tool body including a plurality of cutter blade assemblies, each of the plurality of cutter blade assemblies including a plurality of blades stacked in an alternating side-by-side arrangement, each of the plurality of cutter blade assemblies positioned and fixed in one of the plurality of blade assembly receivers, each of the plurality of blades oriented to extend beyond the periphery of the tool.

16. The finger joint cutting tool assembly of claim 15 wherein each of the at least two tool bodies includes a plurality of blade assembly receivers formed at equal intervals about the periphery of each of the at least two tool bodies.

17. The finger joint cutting tool assembly of claim 15 wherein each of the plurality of cutter blade assemblies further comprise at least one root blade and at least one trim blade stacked in an alternating side-by-side arrangement.

18. The finger joint cutting tool assembly of claim 15 wherein each of the plurality of blades further comprise a first cutting edge and a second cutting edge wherein either the first cutting edge or the second cutting edge of each of the plurality of blades may be oriented for cutting.

19. The finger joint cutting tool assembly of claim 17 wherein each of the plurality of blades further comprise a first cutting edge and a second cutting edge wherein either the first cutting edge or the second cutting edge of each of the plurality of blades may be oriented for cutting.

20. The finger joint cutting tool assembly of claim 15 wherein the plurality of blades further comprise a plurality of root blades, the plurality of root blades stacked in an alternating side-by-side arrangement, the plurality of root blades having a constant root blade interval between each of the plurality of root blades.
